(19) United States
(12) Patent Application Publication
(10) Pub. No.: US 2008/0167052 A1
(43) Pub. Date: Jul. 10, 2008

(54) LOCATION ASSISTED CELL SEARCH AND EMERGENCY CALL OPTIMIZATION

(75) Inventors: Jin Wang, Central Islip, NY (US); Peter S. Wang, E. Setauket, NY (US); Ulises Olvera-Hernandez, Kirkland (CA)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: INTERDIGITAL TECHNOLOGY CORPORATION, Wilmington, DE (US)

(21) Appl. No.: 11/971,131

(22) Filed: Jan. 8, 2008

Related U.S. Application Data
(60) Provisional application No. 60/883,863, filed on Jan. 8, 2007.

(51) Int. Cl. H04Q 7/22

(52) U.S. Cl. 455/456.6

(57) ABSTRACT

Current position information for a user equipment is obtained and is used to assist in cell search and to optimize calls requiring precision positioning made by the user equipment. The position information can be normalized to provide quicker lookup during cell search.

### CROSS REFERENCE TO RELATED APPLICATION

This application claims the benefit of U.S. provisional application No. 60/883,863 and having a filing date of Jan. 8, 2007, which is incorporated by reference as if fully set forth.

### BACKGROUND

The Third Generation Partnership Project (3GPP) has lately initiated the Long Term Evolution (LTE) program to bring new technology, new network architecture, new configurations, and new applications and services to the wireless cellular network in order to provide improved spectral efficiency and faster user experiences.

Given that more and more hand held wireless devices and User Equipment (UEs) are positioning capable, (by using GPS or other positioning methods), this location information can help optimize the UE mobility tasks in LTE to distinguish an LTE UE and system from a traditional 3G UMTS UE and system by providing a faster cell search process and better LTE emergency call service benefits.

Considering that nearly half of all emergency calls are made from mobile phones, the inability to locate subscribers has a high likelihood of resulting in a tragic outcome. The U.S. Federal Communication Commission (FCC) has made a set of regulations called Emergency 911 (E911) for improving the quality and credibility of emergency services for mobile phone users. The first phase of E911 mandated that Public Safety Answering Point attendants of a wireless communication network have to be able to know an emergency caller's phone location. Subsequently, the FCC determined a more stringent set of requirements for obtaining information about emergency callers. It required the implementation of location techniques for specifying a caller's location in a defined accuracy window.

Once it is fully implemented, wireless E911 will provide an accurate location for emergency calls from a wireless device. As such, there is an ongoing need for improving the UE positioning methods to provide better accuracy for locating UEs.

Prior to LTE, UE positioning information was only used in UMTS/GSM for assisted GPS (A-GPS) UE positioning and location services (i.e. purely location service oriented). UMTS mobility functionalities, such as the cell search, cell reselection and emergency call handling, did not utilize positioning information assistance.

When a UE is powered on and searches the radio environment for a suitable cell to camp on, it usually performs a “stored information” cell search with some previously stored cell information (usually a list) for relatively prior knowledge-based operation, versus an “initial” cell search approach where no list of prior cell knowledge exists.

The UMTS stored information typically contains additional cell parameters, such as the carrier frequencies, scrambling codes, or cell timing offsets from previously stored, (i.e. measured or experienced), radio or network information elements or network and cell identities from previous operations. However, this stored information basically comprises cell access parameters that are cell dependant, given the radio propagation limitation of a serving cell.

In practice, a UE in the cell search stage spends time to identify a cell in the UE's power-on site or other travel site, which is only one of the many locations that the UE has previously interacted for access. As a result, the current stored information provides rather limited help in terms of the cell search time reduction.

The traditional “stored information” cell search still lacks the capability for quickly identifying, with respect to the location of the UE power-on, the cells whose access information has been saved in the “stored information.” Accordingly, there is a compelling need for quickly and accurately locating a UE in a wireless network requiring emergency help

### SUMMARY

The present method comprises utilization of user equipment (UE) positioning information from a source, such as the global positioning system (GPS) or other sources that obtain positioning information before cell search, for optimizing the UE cell search process.

### BRIEF DESCRIPTION OF THE DRAWINGS

A more detailed understanding may be had from the following description, given by way of example and to be understood in conjunction with the accompanying drawings wherein:

FIG. 1 is a flowchart of a method for a User Equipment (UE) performing a GPS assisted stored information cell search;

FIG. 2 is a flowchart of a method for location information normalization;

FIG. 3 is a diagram of coordinate comparison to determine the location of a UE;

FIG. 4 is a diagram of coordinate system rotation to determine the location of a UE;

FIG. 5 is a diagram of a computationally simple inclusion test to determine the location of a UE;

FIG. 6 is a flow diagram of an existing UE based network assisted with GPS method; and

FIG. 7 is a diagram of wireless network assisted GPS.

### DETAILED DESCRIPTION

When referred to hereafter, the terminology “user equipment (UE)” includes but is not limited to a wireless transmit/receive unit (WTRU), a mobile station, a fixed or mobile subscriber unit, a pager, a cellular telephone, a personal digital assistant (PDA), a computer, or any other type of user device capable of operating in a wireless environment. When referred to hereafter, the terminology “base station” includes but is not limited to a Node-B, a site controller, an access point (AP), or any other type of interfacing device capable of operating in a wireless environment.

There are many different types of GPS devices and different UE positioning methods that could be used with the present teachings. The UE position determination method may return the latest measured or calculated geographical positioning for use in UE cell search or other UE operations.

Location Information for UE Cell Search

This optimization method quickly identifies the visited cells in the UE power-on site or other sites to reduce the cell search process duration. The use of the UE's geographical positioning information can thereby help in reducing the power consumed by the UE for cell search.

The UE can determine and store the positioning information for later cell search, (such as LTE cell search). During a cell search, the UE can use the currently available positioning information and compare it to the stored information for accessing those previously visited cell or cells.

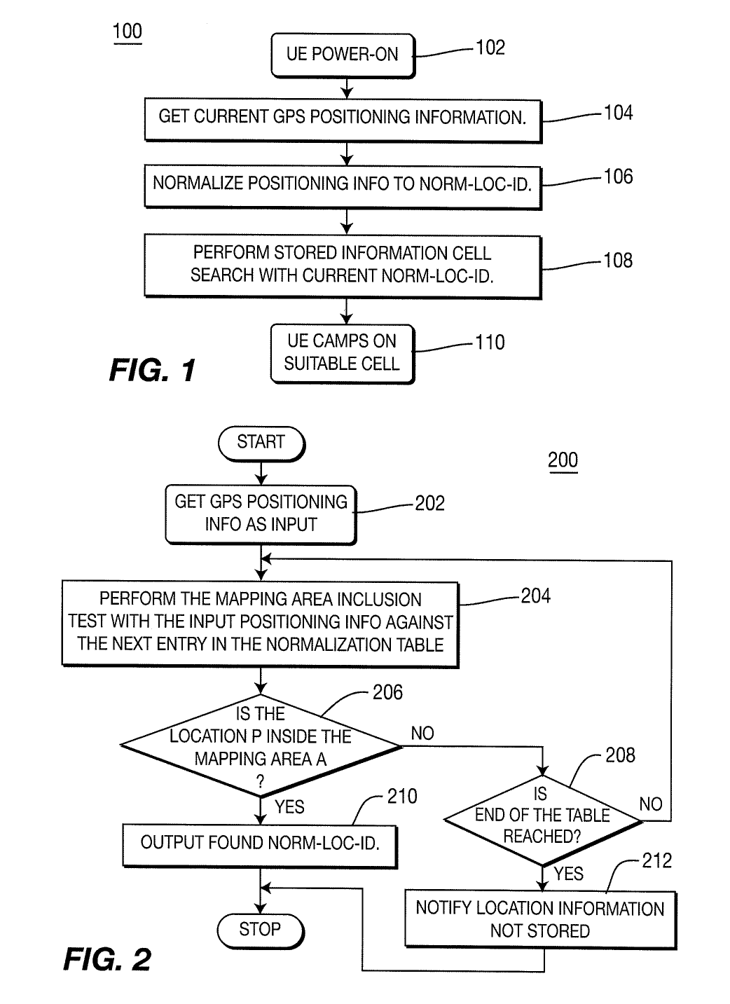

FIG. 1 is a flowchart of a method 100 for performing GPS positioning assisted stored information cell search by the UE, (such as with LTE cell search). As the UE powers up (block 102) (or is in another type of cell selection occasion) and the cell search stage is initiated, the UE obtains its positioning information by GPS or other methods that are well known (block 104). As will be described in greater detail hereafter, the positioning information is normalized to the Norm-Loc-Id (block 106) and the UE performs the indexed search (binary, hash, or other) on the proposed stored information (as shown in Table 1) to determine if it is among previously visited cells. It should be noted that identification numbers 24, 35 and 77 that are listed in Table 1 do not have a particular meaning herein. They have been used to illustrate different identifications for locations. If the positioning information matches information stored in memory, the UE then retrieves the stored cell access information (block 108) for camping on a suitable cell (block 110) with the minimum delay.

Table 1 suggests the organization of the proposed positioning-assisted stored information for LTE UE cell search. The stored information table is indexed by a location value, which can roughly reduce a linear search procedure to a binary (or hash) search procedure, thus minimizing the cell search time, and consequently, the power consumed by the UE. The resulting normalized location value is a combination of the network, the cells and GPS coordinates—all of which assist in providing an accurate location of the UE.

TABLE 1
Organization of Location assisted
Stored Information for Cell Search

| Normalized | Network and/or | |
|---|---|---|
| Location Value | Cell Identities | Cell Access Information |
| Norm-Loc-Id-24 | PLMN-Id, TA-Id, | Carrier Frequency (example: |
| | Cell-Id(s) | URAFCN), scrambling code, |
| | | timing offset, etc. |
| Norm-Loc-Id-35 | | |
| Norm-Loc-Id-77 | | |

During UE operation, a UE may periodically, or based on an event (i.e., at the time of cell switching), use the available positioning information and store the information with the additional experienced cell access information. This information can be stored in memory and eventually saved to semi-permanent storage or a Universal Integrated Circuit Card (UICC) device for further cell search or other use.

FIG. 2 is a flowchart of method 200 for using the Norm-Loc-Id for UE search which depicts blocks 104 and 106 of FIG. 1 in greater detail. The method 200 determines whether a UE is located in a defined area. The UE obtains the positioning information from GPS or by other means (block 202). The UE then performs a mapping area inclusion test that determines whether a point having a set of coordinates is within a given mapping area and compares it with an existing entry in the normalization table (block 204). If the coordinates of point P are within a given area (block 206), the Norm-Loc-Id is determined (block 210). In the case where the point P is not within the mapping area (block 208), notification that the location information is not present in the current table is generated (block 212).

Positioning Information Normalization for Stored Information

Given that the positioning information input typically would comprise four values, (i.e., the longitude value and hemisphere indication which could be combined, and the latitude value and the hemisphere indication), they may be normalized into a single standard format, as shown by the Norm-Loc-Id of Table 1. This facilitates quick storage, and searching and compared with prior search processes.

There are several options in performing such a the normalization. The easiest way is to have Norm-Loc-Id=Longitude×180+Latitude. Hemisphere indication is not included in the normalization, but it will be taken into account where the Norm-Loc-Id is used. The formula for latitude and longitude in terms of the Norm-Loc-Id can be given by the following equations:

Latitude=Norm-Loc-Id % 180 (this is a remainder operator)

Longitude=Norm-Loc-Id div 180.

This determination is not ideal as it does not distinguish the normal wireless network coverage area from the location areas where there is no wireless radio coverage, and it is also difficult to get matched against when performing the cell search. In addition, this determination needs a large number of bits for storing the normalized value (Norm-Loc-Id).

To minimize the large number of bits and thus the storage requirements, a pointer method may be used. One such pointer that may be employed is the use of a mapping table. A mapping table maps the coordinates (four terminal points) of a geographical rectangular area which may cover roughly one or more LTE cells to a predetermined Norm-Loc-Id. This mapping table may be standardized in accordance with LTE, 3GPP or other organization bodies, or may be defined and agreed upon by a number of network providers having mobile roaming agreements. It may even provide benefits when used as a proprietary method to enhance the stored information cell search. Table 2 describes the table organization for location information normalization.

TABLE 2
Location Information Normalization Table

| | | Network |
|---|---|---|
| | | and Cell |
| | Normalized | Identities |
| Mapping Area Coordinates | Location Value | (optional) |
| NE-val, NW-val, SE-val, SW-val, NS- | Norm-Loc-Id-24 | PLMN-Id, |
| h-bit (optional), EW-h-bit (optional) | | TA-Id, |
| | | Cell-Id(s) |
| NE-val-2, NW-val-2, SE-val-2, SW-val- | Norm-Loc-Id-35 | |
| 2, NS-h-bit (optional), EW-h-bit | | |
| (optional) | | |
| ;;;;; | Norm-Loc-Id-77 | |

In the Mapping Area Coordinates column, there are four to six location information mapping coordinates and either four or all six mapping coordinates are used to compare with the input UE positioning information to determine a Norm-Loc-Id.

The values NE-val, NW-val, SE-val and SW-val define a rectangular geographical area within which the Norm-Loc-Id is mapped. A simple algorithm can then be used for this normalization. For example, comparisons of input longitude and latitude values to the defined area coordinates may determine whether or not the input UE position is within the area.

The rectangular area defined by the coordinates may not be necessarily “horizontal” (as will be described in greater detail hereafter). Thus, the comparison may be solely a linear comparison. In case there is no coverage at a given point using a set of coordinates, it may be possible to use one or two terminal points of the area to generate a new area which has coverage and includes the point.

Furthermore, the geographical area coordinates do not have to include four points or comprise a rectangle. The geographical area could be n (3<=n<=M) sides where M is the number of sides of a polygon. Practically, M is bounded by the number of coordinates and the complexity of the comparison algorithm. Likewise, the geographical area could be any shape, but is bounded by the complexity of the comparison algorithm.

Rectangular Mapping Area Inclusion Test Algorithm

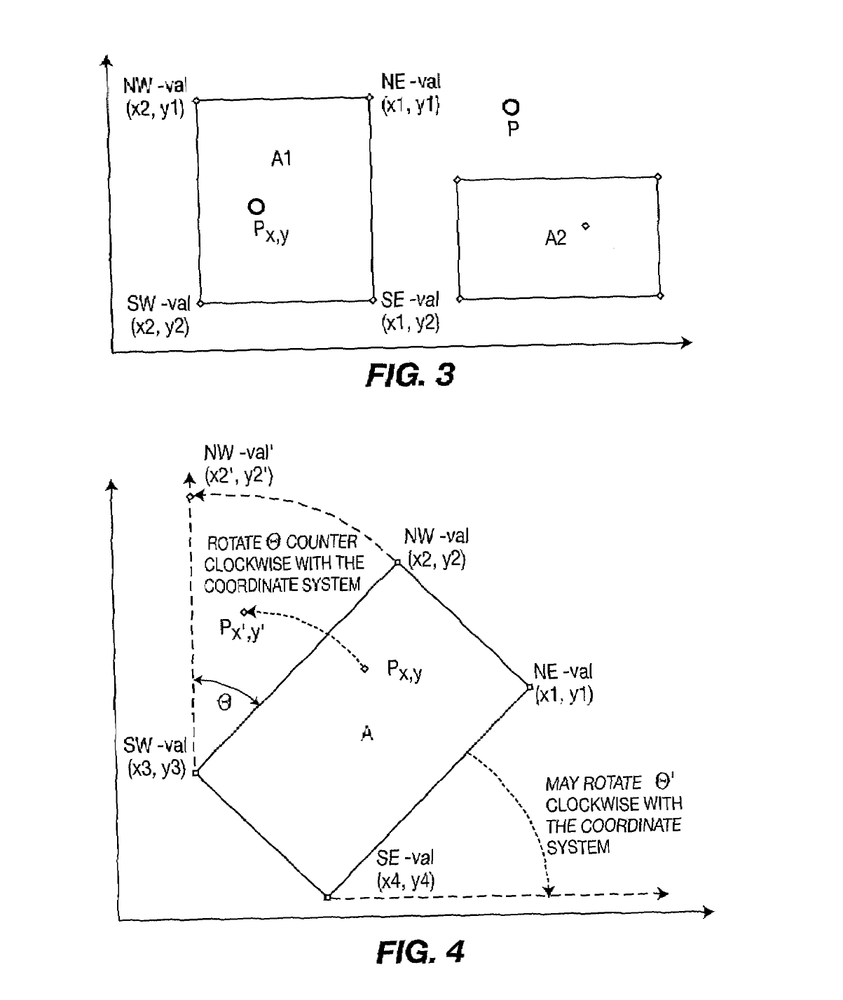

Given a two-coordinate point P_{x, y}-x for longitude, y for latitude) and the rectangular area A defined by the NE-val, NW-val, SE-val and SW-val coordinates, the following alternate procedures can determine whether the positioning input point P is bounded by the mapping area A or not. FIGS. 3, 4 and 5 depict different alternatives of block 204 (FIG. 2) in greater detail.

In a first alternative, if the mapping area A with coordinates are flat-horizontal or upright-vertical as shown in FIG. 3, then simple comparisons of x and y against the xy-coordinates of NE-val, NW-val, SE-val and SW-val would determine if P_{x,y} is in the mapping area A. That is, whether x is between x1 and x2 and y is between y1 and y2 in FIG. 3.

In a second alternative, if the mapping area A is slanted as shown in FIG. 4, then a rotation of the coordinate system together with the location information point P_{x,y} could reduce the operation to the first alternative for inclusion determination. A rotation angle θ would be determined using the tangent relationship of the mapping area coordinates before the rotation. The rotation direction would also be determined in order to involve with the right transformation matrix (counter-clockwise) for calculating the new coordinates (x′ and y′) for the rotation:

$$[ \begin{matrix}{x}^{′} \\ {y}^{′}\end{matrix} ] = [ \begin{matrix}cos θ & - sin θ \\ sin θ & cos θ\end{matrix} ] [ \begin{matrix}x \\ y\end{matrix} ]$$

All four points defining the mapping area A and the positioning information P are consistently rotated in the coordinate system as represented in FIG. 4. Consequently, by the application of the rotation, the second alternative can be essentially reduced to the first alternative, (i.e., the mapping area rectangle is upright vertically or flat horizontally), and simple comparisons for P within A can be executed easily.

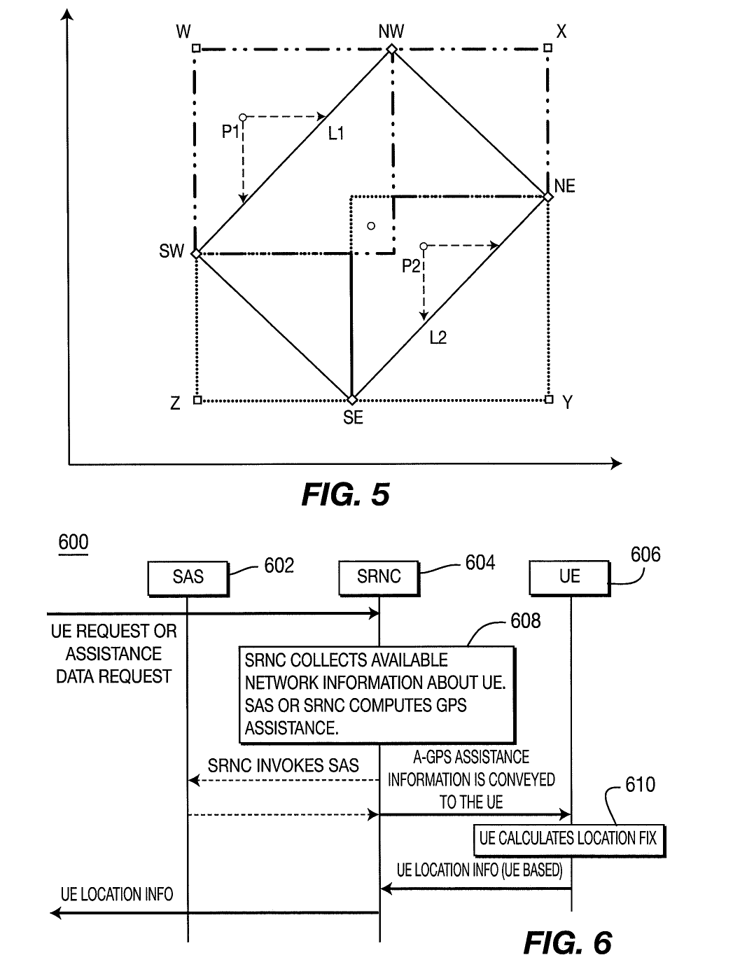

In a third alternative shown in FIG. 5, translation of the original mapping area A into an “enclosure area” may be performed. Given the mapping area A with vertexes NW, NE, SE and SW, an enclosure area WXYZ is derived. If the input positioning point P_{x,y} is inside the enclosure area such as P1 and P2, it must then be determined if it is in one of the four smaller rectangles, such as the P1 in the rectangle (W,NW,O,SW). Plugging the P1 coordinates (x, y) into the slope equation for line L1 may determine that P1 is not included in the mapping area A. Similarly, testing P2 with the slope equation of L2 would determine that it is included within the mapping area A.

The optional NS-h-bit and the EW-h-bit values indicate whether the area is in the north/south hemisphere in terms of latitude and is in the east/west hemisphere in terms of longitude. These values may be matched with the hemisphere information from the UE input hemisphere part. Four normalization tables, (or less—depending on the cell coverage areas, for which the UE is to be used), can be established and the input positioning information hemisphere indicators dictate which table to use.

FIG. 6 is a flow diagram of data interchange (600) between a GPS, the network and the UE as suggested by 3GPP. The Stand Alone Mobile Location Center (SAS) (block 602) is an optional network element and the call segments do not apply in a network where the UE Positioning resides within the Serving Radio Network Controller (SRNC) (block 604). The operation begins with an authenticated request for positioning information about a UE from an application in the core network being received at the SRNC (block 604). The SRNC acts as interface between the Core Network (CN) and the UE Positioning entities in the Universal Terrestrial Radio Access Network (UTRAN). The SRNC (block 604) considers the request and the capabilities of the UE and the UTRAN. In networks that include the SAS (block 602), the SRNC may invoke the SAS via the Iupc interface. Depending on the UE capabilities, the network sends to the UE certain GPS assistance information (block 602). This information may include: the reference time for GPS, the satellite IDs, the Doppler frequency, the search window and its centre, the ephemeris and clock corrections, the almanac, and other information (block 606).

The UE returns the position details to the SRNC (block 610). This position detail includes the position, the estimated accuracy of the results and the time of the detail. In networks that include the SAS, the SAS passes the position estimate to the SRNC. For others, the SRNC passes the position estimate to the CN. As shown, this process 600 can be quite lengthy.

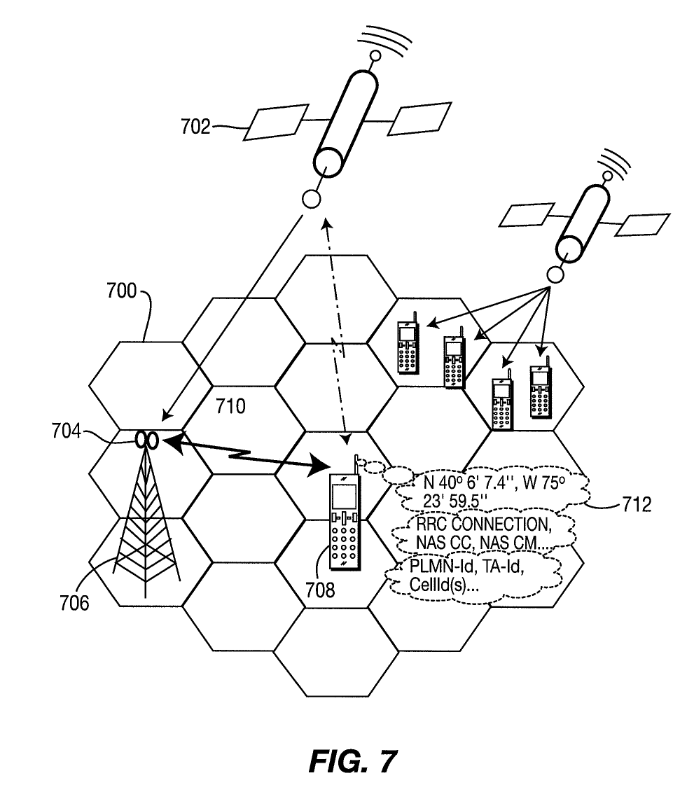

FIG. 7 depicts a UE utilizing the present teachings for an Emergency Call Request. The UE positioning information may also be included in the following one or more LTE UE emergency call messages, specifically: the RRC CONNECTION REQUEST message with the cause=Emergency-call; the NAS CC message EMERGENCY SETUP; and the NAS CM message CM SERVICE REQUEST. The UE 708 is operating in a given area comprising a plurality of different cells. Assuming that the UE 708 making an emergency call is GPS enabled via satellite (702), the UE exchanges information with the eNB 706 having an antenna 704. The message 712 between the UE and the eNB is transmitted over radio link 710. The message 712 comprises several pieces of information concatenated into a single message, called the Norm-Loc-Id.

When an emergency call is made, it is preferable to determine the caller's position at the earliest possible moment.

The position information can be obtained from a GPS device (which is faster) or any other UE positioning methods when available. The UE positioning information element to be included in the RRC CONNECT REQUEST message for an emergency call, the NAS MM CM SERVICE REQUEST message and the NAS CC EMERGENCY SETUP message may comprise like the following:

TABLE 3
Parameters in UE Positioning IE

| Information Element/ | | | Type and | |
|---|---|---|---|---|
| Group name | Need | Multi | Reference | Semantics description |
| Latitude sign | MP | | Enumerated | |
| | | | (North, South) | |
| Degrees Of Latitude | MP | | Integer | The IE value (N) is derived |
| | | | (0 . . . 2²³ −1) | by this formula: |
| | | | | N ≦ 2²³ X/90 < N + 1 |
| | | | | X being the latitude in degree |
| | | | | (0° . . . 90°) |
| Degrees Of Longitude | MP | | Integer | The IE value (N) is derived |
| | | | (−2²³ . . . 23 − 1) | by this formula: |
| | | | | N ≦ 2²⁴ X/360 < N + 1 |
| | | | | X being the longitude in |
| | | | | degree (−180° . . . +180°) |

The hemisphere indication for Longitude is not required since the IE “Degrees of Longitude” has the coverage of −180 degrees to +180 degrees.

It should be noted that this positioning information may also be used for UE applications requiring positioning the UE with high accuracy such as, for example, emergency call operation, position sensitive billing and fraud detection in Long Term Evolution (LTE).

Although the features and elements are described in particular combinations, each feature or element can be used alone without the other features and elements or in various combinations with or without other features and elements. The methods or flow charts provided herein may be implemented in a computer program, software, or firmware tangibly embodied in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

A processor in association with software may be used to implement a radio frequency transceiver for use in a wireless transmit receive unit (WTRU), user equipment (UE), terminal, base station, radio network controller (RNC), or any host computer. The WTRU may be used in conjunction with modules, implemented in hardware and/or software, such as a camera, a video camera module, a videophone, a speakerphone, a vibration device, a speaker, a microphone, a television transceiver, a hands free headset, a keyboard, a Bluetooth® module, a frequency modulated (FM) radio unit, a liquid crystal display (LCD) display unit, an organic light-emitting diode (OLED) display unit, a digital music player, a media player, a video game player module, an Internet browser, and/or any wireless local area network (WLAN) module.

What is claimed is:

1. A User Equipment (UE) configured for optimization of the cell search process comprising:
an antenna for receiving at least one position signal;
a processor configured to determine a position of the UE based on said position signal; and
a memory for storing said determined position; wherein said processor uses said stored position to perform a cell search.

2. The UE of claim 1, wherein said stored position is combined with at least one other parameter to generate a position value.

3. The UE of claim 1, wherein said at least one other parameter comprises at least one of a cell identification, public land mobile network identification, carrier frequency, scrambling code and timing offset.

4. The UE of claim 1, wherein said processor receives the current position of the UE on a periodic basis.

5. The UE of claim 1, wherein said processor determines the current position of the UE based on an event.

6. The UE of claim 1, wherein said processor normalizes the position information.

7. The UE of claim 6, wherein said processor performs the normalization based on a mapping table and a mapping area inclusion test.

8. The UE of claim 1, wherein said processor is configured to determine whether the UE is within a predefined area, comprising:
normalizing said position of the UE; and
comparing said normalized position with the boundaries of said predefined area.

9. A method for optimization of the cell search process within a user equipment (UE) comprising:
receiving at least one position signal;
determine a position of the UE based on said position signal;
storing said determined position; and
retrieving and using said stored position to perform a cell search.

10. The method of claim 9, further comprising combining said stored position with at least one other parameter to generate a position value.

11. The method of claim 10, wherein said at least one other parameter comprises at least one of a cell identification, public land mobile network identification, carrier frequency, scrambling code and timing offset.

12. The method of claim 9, further comprising receiving said position signal on a periodic basis.

13. The method of claim 9, further comprising determining a current position of the UE based on an event.

14. The method of claim 9, further comprising normalizing said stored position.

15. The method of claim 14, wherein said normalization is based on a mapping table and a mapping area inclusion test.

16. The method of claim 9, further comprising determining whether the UE is within a predefined area, comprising:
normalizing said determined position of the UE; and
comparing said normalized position with the boundaries of said predefined area.
